(19) United States
(12) Patent Application Publication
(10) Pub. No.: US 2005/0087655 A1
(43) Pub. Date: Apr. 28, 2005

(54) Electronic apparatus capable of receiving power cord

(76) Inventor: I-Jung Yang, Taoyuan (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/860,475

(22) Filed: Jun. 3, 2004

(30) Foreign Application Priority Data
Oct. 23, 2003 (TW) 092129486

(51) Int. Cl. F16L 3/00

(52) U.S. Cl. 248/49

(57) ABSTRACT

An electronic apparatus capable of receiving a power cord is disclosed. The electronic apparatus comprises a main body, a power cord connected to the main body in one end, and a plurality of receiving elements having a specific height and respectively disposed on the main body of the electronic apparatus, and thereby allowing the power cord to be entwined and received between the receiving elements.

### FIELD OF THE INVENTION

The present invention relates generally to an electronic apparatus capable of receiving a power cord, and more particularly to an adapter or a power supply capable of receiving a power cord.

### BACKGROUND OF THE INVENTION

In our daily life, electronic apparatuses, such as chargers, transformers, power supplies, adapters and so on, are popular. Generally, these electronic apparatuses include a power cord to enlarge their usable field. However, they do not provide users an adequate and convenient way in receiving the power cord. As a result, when the electronic apparatus is not in use and the power cord needs to be received, it becomes a trouble since the electronic apparatus has no function for receiving the power cord.

Taking an adapter as an example, please refer to FIG. 1, which is a schematic diagram showing a structure of a conventional adapter. As shown in FIG. 1, the adapter mainly includes a main body 11 connected to a power cord 12 in one end. When this conventional adapter is finished used and going to be stored up, users would generally entwine the power cord 12 directly around the main body 11 of the adapter to temporarily receive the power cord 12 for preventing the power cord 12 from being entangled with other objects. In addition, when buying the adapter, there often provides a strap 13 for bundling up the power cord 12 so as to well receive the power cord 12. The above-mentioned two methods for receiving the power cord 12 may seem convenient, but actually contain many drawbacks. For example, randomly entwining the power cord 12 may probably make the power cord 12 loosen and detach from the main body 11 of the adapter in the later storing process. Moreover, when the power cord 12 is entwined around the main body 11 of the adapter, the long power cord 12 would enlarge the volume of the adapter or make the adapter present in an irregular shape, which makes it troublesome to store up the adapter. Besides, the strap 13 is easily lost, and users would be still unable to receive the power cord 12 of the adapter by using the strap 13 in the end.

Therefore, in order to solve the drawbacks of the prior art, it is urged to provide an electronic apparatus capable of receiving the power cord.

### SUMMARY OF THE INVENTION

The main object of the present invention is to provide an electronic apparatus capable of receiving a power cord to solve the problems encountered in the prior art.

To achieve the above-mentioned object, an electronic apparatus capable of receiving a power cord is disclosed. The electronic apparatus includes a main body, a power cord connected to the main body in one end, and a plurality of receiving elements respectively disposed on the main body of the electronic apparatus and having a specific height. Thereby, the power cord is capable of being entwined and received between the receiving elements.

For example, the electronic apparatus applicable in the present invention may be an adapter, a power supply, a transformer, a charger and so on.

Preferably, the receiving element is made of a plastic material or can be made of a metallic material.

Preferably, the receiving element further includes a metallic element.

Preferably, the receiving element can be integrally formed with the main body of the electronic apparatus.

For example, the main body and the receiving element may have a first connecting device therebetween.

Preferably, the first connecting device is a twin adhesive or a Velcro.

For example, the first connecting device comprises at least one knob disposed on the receiving element or the main body, and at least one indentation disposed correspondingly to the knob on the main body or the receiving element and allowing the knob to be disposed in. Thereby, the receiving element can be disposed on the main body.

For example, the first connecting device comprises at least one protrusion disposed on the receiving element or the main body, and at least one groove disposed correspondingly to the protrusion on the main body or the receiving element and allowing the protrusion slide in. Thereby, the receiving element is allowed to be disposed on the main body.

For example, the first connecting device comprises at least one extrusive block disposed on the receiving element or the main body, and at least one hole disposed correspondingly to the extrusive block on the main body or the receiving element, wherein the hole further includes a rounded hole and a rectangular-shaped hole, and the width of the extrusive block is between those of the rounded hole and the rectangular-shaped hole. Thereby the extrusive block is allowed to be placed into the rounded hole and engaged by the rectangular-shaped hole to let the receiving element be disposed on the main body.

Preferably, the main body is integrally formed with the receiving elements.

Preferably, the receiving element further includes a buffer disposed on the receiving element.

Preferably, the receiving element is integrally formed with the buffer or has a second connecting device between the receiving element and the buffer.

For example, the second connecting device comprises at least one knob disposed on the receiving element or the buffer, and at least one indentation disposed correspondingly to the knob on the buffer or the receiving element and allowing the knob to be disposed in. Thereby, the buffer is allowed to be disposed on the receiving element.

For example, the second connecting device comprises at least one protrusion disposed on the receiving element or the buffer, and at least one groove disposed correspondingly to the protrusion on the buffer or the receiving element, and allowing the protrusion slide in. Thereby, the buffer is allowed to be disposed on the receiving element.

For example, the second connecting device comprises at least one extrusive block disposed on the receiving element or the buffer, and at least one hole disposed correspondingly to the extrusive block on the buffer or the receiving element. The hole further includes a rounded hole and a rectangular-shaped hole, and the width of the extrusive block is between those of the rounded hole and the rectangular-shaped hole. Thereby the extrusive block is allowed to be placed into the rounded hole and engaged by the rectangular-shaped hole to let the buffer be disposed on the receiving element.

Preferably, the receiving element further includes a fixing element, such as a clipping ring, for fixing the end of the power cord.

Preferably, the receiving element further includes a plurality of through holes or blind holes disposed on the receiving element.

### BRIEF DESCRIPTION OF THE DRAWINGS

The present invention may best be understood through the following description with reference to the accompanying drawings, in which:

FIG. 1 is a schematic diagram showing a structure of a conventional adapter;

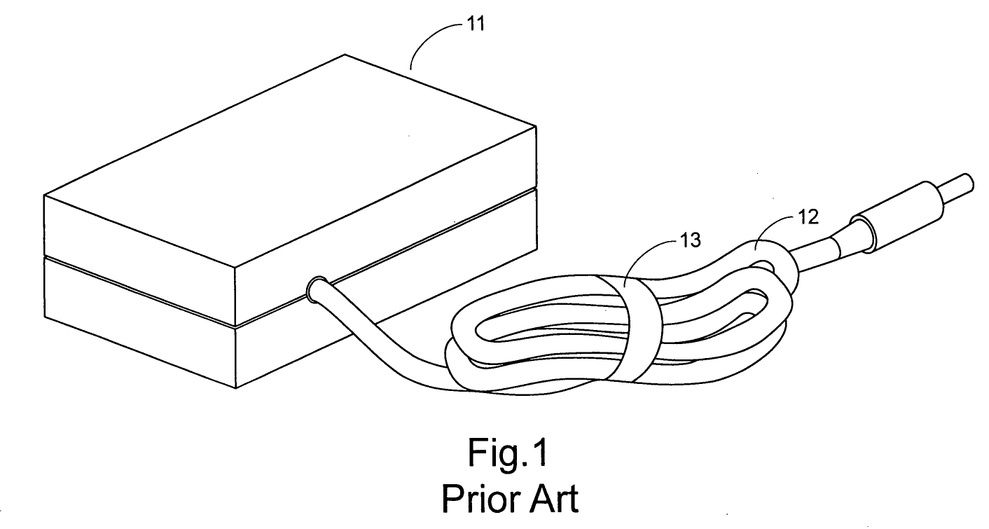

FIG. 2 is the schematic structure diagram illustrating a first preferred embodiment of the electronic apparatus of the present invention;

FIG. 3 is the schematic structure diagram illustrating a second preferred embodiment of the electronic apparatus of the present invention;

FIG. 4 is the schematic structure diagram illustrating a third preferred embodiment of the electronic apparatus of the present invention;

FIG. 5 is the schematic structure diagram illustrating a fourth preferred embodiment of the electronic apparatus of the present invention;

FIG. 6 is the schematic structure diagram illustrating a first preferred embodiment of the first connecting device of the present invention;

FIG. 7 is the schematic structure diagram illustrating a second preferred embodiment of the first connecting device of the present invention; and

FIG. 8 is the schematic structure diagram illustrating a third preferred embodiment of the first connecting device of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The present invention relates to an electronic apparatus capable of receiving a power cord. The electronic apparatus includes a plurality of receiving elements disposed on the main body of the electronic apparatus to enable the power cord of the electronic apparatus to be entwined therebetween and further receiving the power cord by the specific height of the receiving elements. There are numerous kinds of electronic apparatuses that can be applied to the present invention, such as an adapter, a power supply, a charger and so on. Preferred embodiments incorporating the features and advantages of the present invention will be described in the following paragraphs. It is to be realized that the present invention includes various modifications in different respects of the described embodiments, all of which are within the scope of the present invention, and the description herein and the drawings are intended to be taken as illustrative in nature, and are not limitative.

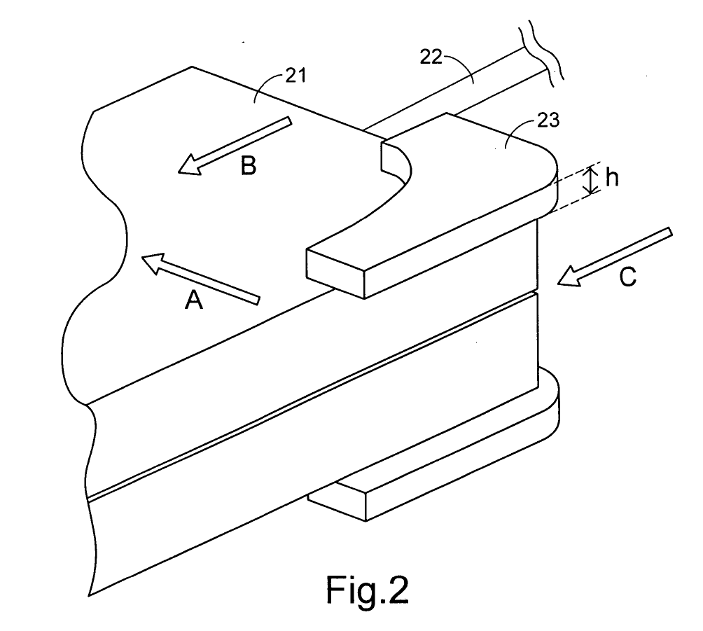

Please refer to FIG. 2, which is the schematic structure diagram illustrating a first preferred embodiment of the electronic apparatus of the present invention. As shown in FIG. 2, the electronic apparatus of the present invention includes a main body 21, a power cord 22 and a plurality of receiving elements 23. Although FIG. 2 only shows two receiving elements 23 respectively disposed on two corners of the main body 21, in fact, other receiving elements are disposed on the rest corners of the main body 21 as the two receiving elements 23 shown in FIG. 2. The power cord 22 is passing through from one side of the main body 21, and the two receiving elements 23 have a specific height h not less than 0.4 mm. When users want to put away the electronic apparatus, the power cord 22 can be entwined in the directions indicated by the three arrows A, B, and C as shown in FIG. 2, and be received between the receiving elements 23. Therefore, when the electronic apparatus is not being used, the power cord 22 can be easily entwined and received between the receiving elements 23 for avoiding the drawbacks of randomly entwining the power cord or using the strap to receive the power cord which occurs in the conventional electronic apparatus.

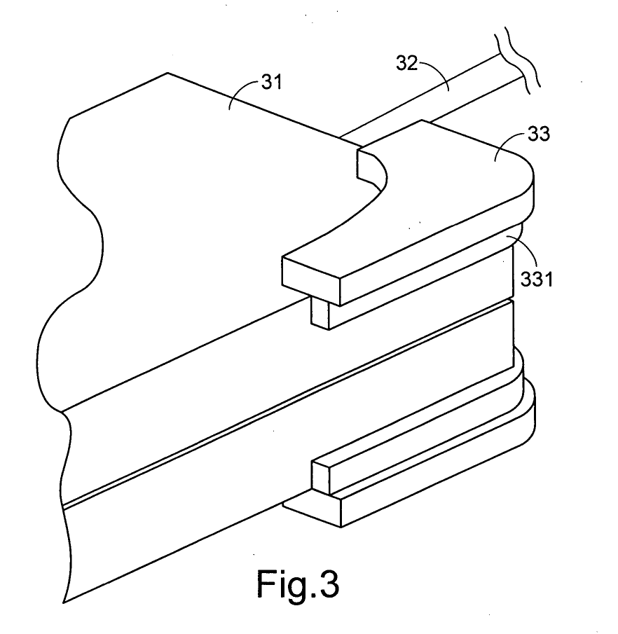

Please refer to FIG. 3, which is the schematic structure diagram illustrating a second preferred embodiment of the electronic apparatus of the present invention. As shown in FIG. 3, the electronic apparatus includes a main body 31, a power cord 32, and a plurality of receiving elements 33 having a buffer 331 disposed on the bottom of the receiving element 33 and covered around the corner of the main body 31. When the electronic apparatus is bumped, the buffers 331 of the receiving elements 33 will absorb the shock of the bump to protect the internal circuit elements of the electronic apparatus from being damaged. In a word, the receiving elements 33 with the buffers 331 not only have the function of receiving the power cord 32 but also prevent the electronic apparatus from being directly bumped to further protect the internal circuit elements of the electronic apparatus.

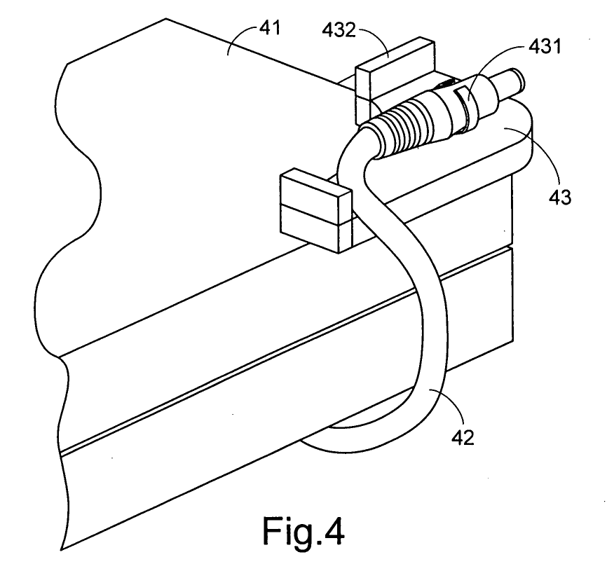

Please refer to FIG. 4, which is the schematic structure diagram illustrating a third preferred embodiment of the electronic apparatus of the present invention. As shown in FIG. 4, the electronic apparatus includes a main body 41, a power cord 42, and a plurality of receiving elements 43. One of the receiving elements 43 has a fixing element 431, for example a clipping ring, for fixing the end of the power cord 42 while the power cord 42 is received between the receiving elements 43. Therefore, the receiving elements 43 can receive the power cord 42 therebetween, and in the meanwhile, the fixing element 431 is capable of fixing the end of the power cord 42 for preventing the power cord from coming off. Furthermore, the receiving element 43 may have a sidewall 432 to prevent the detachment or loosening of the power cord 42 entwined between the receiving elements 43. On the other hand, when the end of the power cord 42 is fixed on the clipping ring 431, the position and the direction of the power cord 42 is also capable of being fixed.

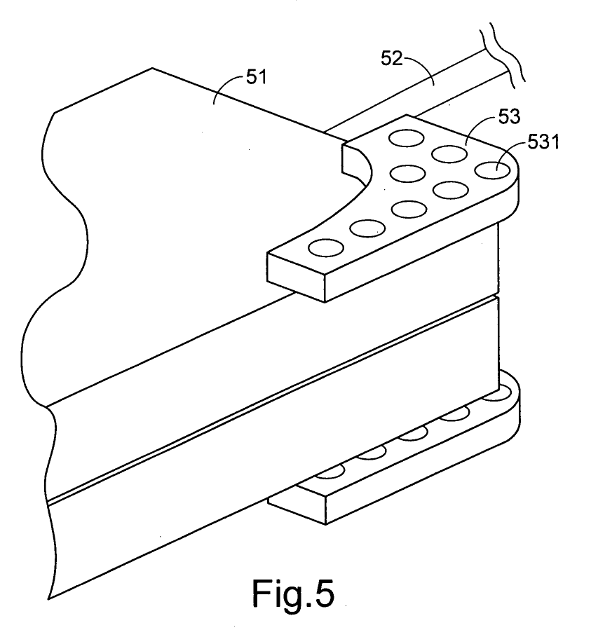

In addition, the receiving elements of the present invention can further include a plurality of through holes for air flowing to dissipate the heat generated from the electronic apparatus. Please refer to FIG. 5, which is the schematic structure diagram illustrating a fourth preferred embodiment of the electronic apparatus of the present invention. As shown in FIG. 5, the electronic apparatus includes a main body 51, a power cord 52, and a plurality of receiving elements 53 having a plurality of through holes 531 (or blind holes (not shown)) for increasing the exposure area of the electronic apparatus in the air and dissipating the heat generated from the electronic apparatus by air flowing.

In the above-mentioned embodiments, the receiving elements of the electronic apparatus capable of receiving the power cord according to the present invention can be integrally formed with the main body of the electronic apparatus. But, in general, for the convenience of using and carrying, it is recommended that the receiving elements are demountably disposed on the main body of the electronic apparatus. Therefore, to make sure that the receiving elements are firmly disposed on the main body of the electronic apparatus, the main body of the electronic apparatus and the receiving elements of the present invention can further have a first connecting device therebetween. A few preferred embodiments of the first connecting device will be enumerated in the following paragraphs. Of course, other connecting devices applicable to the present invention can also be considered.

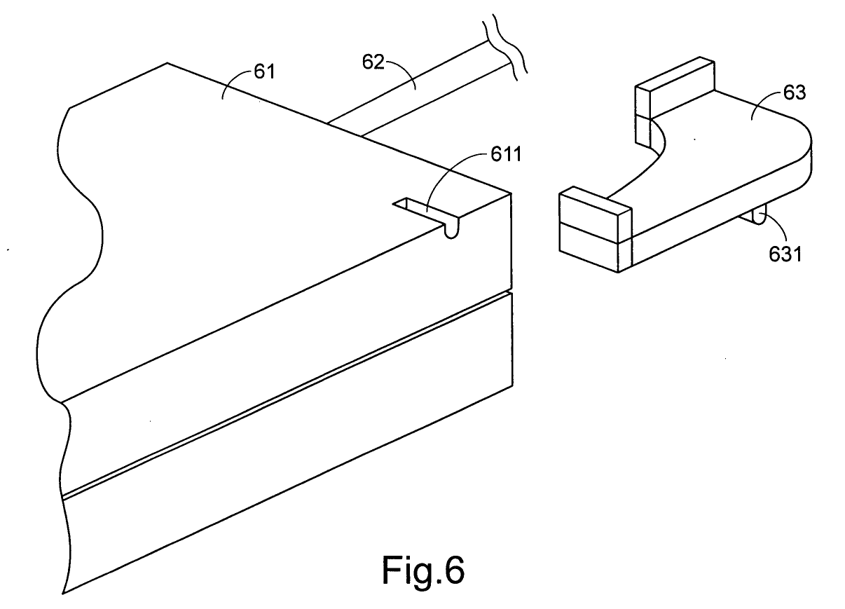

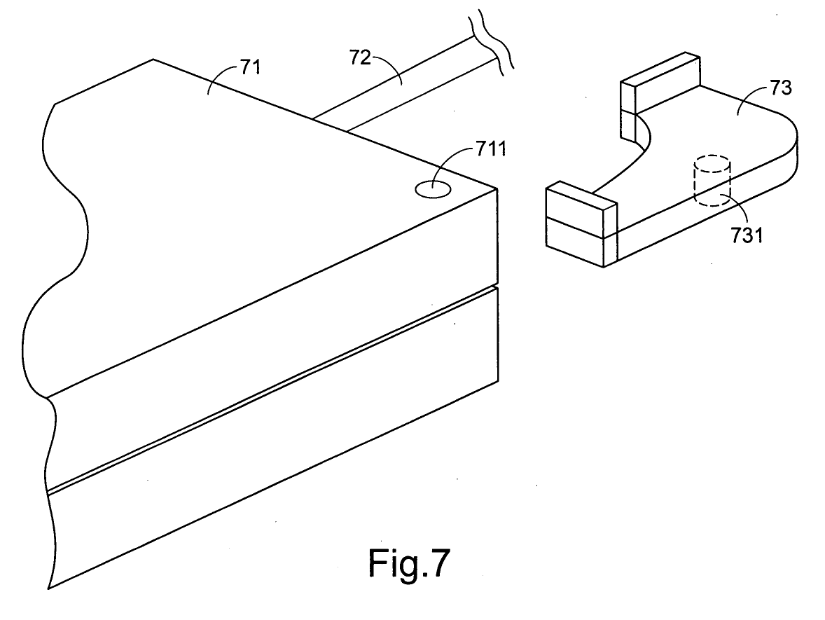

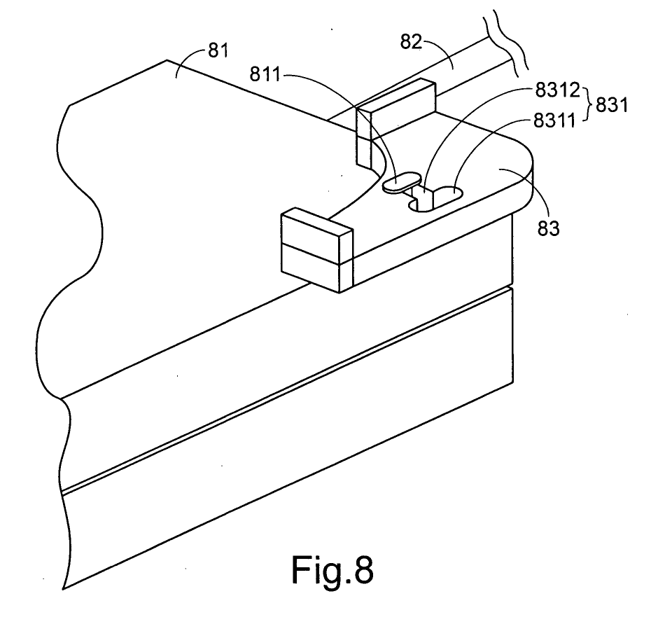

First, please refer to FIG. 6, which is the schematic structure diagram illustrating a first preferred embodiment of the first connecting device of the present invention. As shown in FIG. 6, the first connecting device includes at least one groove 611, and at least one protrusion 631. The protrusion 631 is disposed on the bottom of the receiving element 63, and the groove 611 is disposed correspondingly to the protrusion 631 on the main body 61. Of course, the protrusion and the groove can be interchanged. The groove 611 allows the protrusion 631 to slide in, and thereby the receiving element 63 can be disposed firmly on the main body 61 of the electronic apparatus. Next, please refer to FIG. 7, which is the schematic structure diagram illustrating a second preferred embodiment of the first connecting device of the present invention. As shown in FIG. 7, the first connecting device includes at least a knob 731 and an indentation 711. The knob 731 is disposed on the bottom of the receiving element 73, and the indentation 711 is disposed correspondingly to the knob 731 on the main body 71. Of course, the knob 731 and the indentation 711 can be interchanged. The indentation 711 allows the knob 731 to be disposed in, and thereby the receiving element 73 can be disposed firmly on the main body 71 of the electronic apparatus. On the other hand, the first connecting device can be in other forms. For example, please refer to FIG. 8, which is the schematic structure diagram illustrating a third preferred embodiment of the first connecting device of the present invention. As shown in FIG. 8, the first connecting device includes at least one extrusive block 811 and one hole 831, wherein the extrusive block 811 is disposed on the main body 81, and the hole 831 is disposed correspondingly to the extrusive block 811 on the receiving element 83. The same, the extrusive block 811 and the hole 831 can be interchanged. The hole 831 further includes a rounded hole 8311 and a rectangular-shaped hole 8312, and the width of the extrusive block 811 is between those of the rounded hole 8311 and the rectangular-shaped hole 8312. After the extrusive block 811 is placed into the rounded hole 8311 and slid towards the direction of the rectangular-shaped hole 8312, the extrusive block 811 will be engaged by the rectangular-shaped hole 8312 and thereby the receiving element 83 can be firmly disposed on the main body 81.

Certainly, the first connecting device between the receiving element and the main body of the electronic apparatus can be a twin adhesive or a Velcro. Besides, in the embodiment shown in FIG. 3, a second connecting device similar to the first connecting device can also be disposed between the receiving element and the buffer so as to ensure the buffer is firmly disposed on the receiving element. Because the second connecting device can be the same with or similar to the first connecting device, there are no redundant descriptions on the second connecting device.

To sum up, the electronic apparatus capable of receiving a power cord of the present invention, which includes receiving elements disposed on the corners of the electronic apparatus, can receive the power cord between the several receiving elements and store the power cord by the specific height h of the receiving elements. Further, in the present invention, because the several receiving elements can be disposed on different corners of the electronic apparatus, the power cord is capable of being received and entwined in different directions accordingly. Besides, the receiving elements increase the heat-dissipating area of the electronic apparatus and keep away the electronic apparatus from contacting other objects directly by the specific height, so that the air is capable of flowing around the electronic apparatus to dissipate the heat thereof. On the other hand, to further enhance the heat-dissipating effect, the receiving elements may further include metallic elements (not shown), such as a piece of aluminum element and so on. Also, because the electronic apparatus according to the present invention has the receiving elements, which may absorb the strength to protect the internal circuit elements of the electronic apparatus from being damaged. That is, the electronic apparatus capable of receiving a power cord according to the present invention can not only solve the drawbacks of receiving the power cord in the conventional art but also increase heat-dissipating effect and protect the internal circuit elements of the electronic apparatus. Therefore, it can be said that the electronic apparatus capable of receiving a power cord disclosed here is a novel, advanced, and highly practicable invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An electronic apparatus capable of receiving a power cord, comprising:
a main body;
a power cord connected to said main body in one end; and
a plurality of receiving elements having a specific height and respectively disposed on said main body of said electronic apparatus;
thereby allowing said power cord to be entwined and received between said receiving elements.

2. The electronic apparatus capable of receiving a power cord according to claim 1 wherein said electronic apparatus is one selected from a group consisting of an adapter, a power supply, a transformer and a charger.

3. The electronic apparatus capable of receiving a power cord according to claim 1 wherein said receiving element is made of a plastic material.

4. The electronic apparatus capable of receiving a power cord according to claim 3 wherein said receiving element further includes a metallic element.

5. The electronic apparatus capable of receiving a power cord according to claim 1 wherein said receiving element is made of a metallic material.

6. The electronic apparatus capable of receiving a power cord according to claim 1 wherein said receiving element is integrally formed with said main body.

7. The electronic apparatus capable of receiving a power cord according to claim 1 wherein said main body and said receiving element have a first connecting device therebetween.

8. The electronic apparatus capable of receiving a power cord according to claim 7 wherein said first connecting device is a twin adhesive or a Velcro.

9. The electronic apparatus capable of receiving a power cord according to claim 7 wherein said first connecting device comprises:
at least one knob disposed on said receiving element or said main body; and
at least one indentation disposed correspondingly to said knob on said main body or said receiving element, and allowing said knob to be disposed in;
thereby allowing said receiving element to be disposed on said main body.

10. The electronic apparatus capable of receiving a power cord according to claim 7 wherein said first connecting device comprises:
at least one protrusion disposed on said receiving element or said main body; and
at least one groove disposed correspondingly to said protrusion on said main body or said receiving element, and allowing said protrusion slide in;
thereby allowing said receiving element to be disposed on said main body.

11. The electronic apparatus capable of receiving a power cord according to claim 7 wherein said first connecting device comprises:
at least one extrusive block disposed on said receiving element or said main body; and
at least one hole disposed correspondingly to said extrusive block on said main body or said receiving element, wherein said hole further includes a rounded hole and a rectangular-shaped hole, and the width of said extrusive block is between those of said rounded hole and said rectangular-shaped hole;
thereby allowing said extrusive block to be placed into said rounded hole and engaged by said rectangular-shaped hole to let said receiving element be disposed on said main body.

12. The electronic apparatus capable of receiving a power cord according to claim 1 wherein said specific height is not less than 0.4 mm.

13. The electronic apparatus capable of receiving a power cord according to claim 1 wherein said receiving element further includes a buffer disposed on said receiving element.

14. The electronic apparatus capable of receiving a power cord according to claim 13 wherein said receiving element is integrally formed with said buffer or has a second connecting device between said receiving element and said buffer.

15. The electronic apparatus capable of receiving a power cord according to claim 14 wherein said second connecting device comprises:
at least one knob disposed on said receiving element or said buffer; and
at least one indentation disposed correspondingly to said knob on said buffer or said receiving element, and allowing said knob to be disposed in;
thereby allowing said buffer to be disposed on said receiving element.

16. The electronic apparatus capable of receiving a power cord according to claim 14 wherein said second connecting device comprises:
at least one protrusion disposed on said receiving element or said buffer; and
at least one groove disposed correspondingly to said protrusion on said buffer or said receiving element, and allowing said protrusion slide in;
thereby allowing said buffer to be disposed on said receiving element.

17. The electronic apparatus capable of receiving a power cord according to claim 14 wherein said second connecting device comprises:
at least one extrusive block disposed on said receiving element or said buffer; and
at least one hole disposed correspondingly to said extrusive block on said buffer or said receiving element, wherein said hole further includes a rounded hole and a rectangular-shaped hole, and the width of said extrusive block is between those of said rounded hole and said rectangular-shaped hole;
thereby allowing said extrusive block to be placed into said rounded hole and engaged by said rectangular-shaped hole to let said buffer be disposed on said receiving element.

18. The electronic apparatus capable of receiving a power cord according to claim 1 wherein one of said receiving elements further includes a fixing element for fixing the end of said power cord.

19. The electronic apparatus capable of receiving a power cord according to claim 18 wherein said fixing element is a clipping ring.

20. The electronic apparatus capable of receiving a power cord according to claim 1 wherein said receiving element further includes a plurality of through holes or blind holes disposed on said receiving element.
